(19) United States
(12) Patent Application Publication
(10) Pub. No.: US 2025/0164327 A1
(43) Pub. Date: May 22, 2025

(54) LIQUID METAL DEFORMATION SENSOR

(71) Applicant: Worcester Polytechnic Institute, Worcester, MA (US)

(72) Inventors: Pratap Rao, Northborough, MA (US); Ritwik Pandey, Worcester, MA (US); Markus P. Nemitz, Southborough, MA (US)

(21) Appl. No.: 18/955,546

(22) Filed: Nov. 21, 2024

Related U.S. Application Data
(60) Provisional application No. 63/601,612, filed on Nov. 21, 2023.

(51) Int. Cl. G01L 1/22; G01L 5/00

(52) U.S. Cl. CPC G01L 1/2287; G01L 5/0019

(57) ABSTRACT

A flexible sensor invokes a fluid sensing medium in an encapsulation for detecting pressure based on movement of the fluid in the flexible encapsulation. The fluid sensing medium is a conductive liquid which exhibits a varied resistance to changes in a cross section resulting from deformation of the flexible encapsulation. A flexible substrate with a fused planar material adheres around the fluid sensing medium. The fluid sensing medium maty be deposited or placed by an extrusion or print nozzle, a screen or other selective application. A deposited bead or run of the fluid sensing medium has a viscosity for holding a shape until the flexible planar material is adhered. A narrow, elongated and patterned or curved run provides a length of encapsulated fluid which is responsive to deformation from pressure. Insertion of electrical leads at opposed ends of the run provides a measurable electrical resistance that varies with fluid movement.

### RELATED APPLICATIONS

This patent application claims the benefit under 35 U.S.C. § 119(e) of U.S. Provisional Patent App. No. 63/601,612, filed Nov. 21, 2023, entitled “LIQUID METAL DEFORMATION SENSOR,” incorporated herein by reference in entirety.

### BACKGROUND

Certain specialized applications require force/pressure sensing in environments that are not suitable for traditional ridged sensors, such as loadcells and piezoelectric devices. Flexible alternatives tend to be noisy (layered capacitive sensors) or lack linearity and have high hysteresis (force sensitive resistors—FSRs). Soft/compliant force sensors find uses in various soft robotic and biomedical applications.

### SUMMARY

A flexible sensor invokes a fluid sensing medium in an encapsulation for detecting pressure based on movement of the fluid in the flexible encapsulation. The fluid sensing medium is a conductive liquid which exhibits a varied resistance to changes in a cross section resulting from deformation of the flexible encapsulation. A flexible substrate bonds with flexible planar material for adhering and encapsulating around the regions containing the fluid sensing medium. The fluid sensing medium may be deposited or placed by an extrusion or print nozzle, a screen or other selective application. A deposited bead or run of the fluid sensing medium has a viscosity for holding a shape until the flexible planar material is adhered. A narrow, elongated and patterned or curved run provides a length of encapsulated fluid which is responsive to deformation from pressure. Insertion of electrical leads at opposed ends of the run provides a measurable electrical resistance that varies with fluid movement.

Configurations herein are based, in part, on the observation that pressure sensors are invoked in flexible contexts and/or for lower magnitudes of pressure force, such as garments, robotics and non-industrial settings. Unfortunately, conventional approaches to pressure sensors suffer from the shortcoming that they often employ rigid materials intended to measure large magnitudes or resulting from heavy, dense objects. Confined, small or on-person (garment) settings may not be amenable to bulky, solid sensing devices.

Accordingly, configurations herein substantially overcome the shortcomings of conventional pressure sensors by providing a flexible, generally flat or planar shaped pressure sensor configured for a variable resistive response to pressure or deformation. A liquid filled channel formed between convex forms in fused polymer sheets defines an encapsulated fluid volume of conductive material. Deformation or pressure compresses or bends the polymer sheets, affecting a cross section of the fluid channel formed between the fused sheets. Variance of the cross section changes an electrical resistance encountered by a current passed through the encapsulated fluid. A printed or deposited bead of a liquid metal encapsulated between the sheets provides a liquid, gel or pliable conductive material for resistance measurements.

In further detail, a method for forming a pressure sensor includes depositing a conductive material onto a substrate, and encapsulating the conductive material with a flexible planar material layered onto the substrate. A pair of electrodes engaged e in communication with the encapsulated conductive material are configured for sensing an electrical resistance variation in the conductive material from deformation of the flexible planar material and/or the encapsulated conductive material.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a top or plan view of a sensor formed according to configurations herein;

FIG. 2 is a side elevation of an axial view of the sensing medium as in FIG. 1;

FIGS. 3A-3F show formation of the pressure sensor as in FIGS. 1-2;

FIGS. 4A-4B show a perspective, exploded view of sensor formation as in FIGS. 1-3; and

FIG. 5 shows a graph depicting a change in detected resistance.

### DETAILED DESCRIPTION

Configurations herein depict an example construction and operation of an encapsulated liquid metal sensing device suitable for soft or deformable deployment environments.

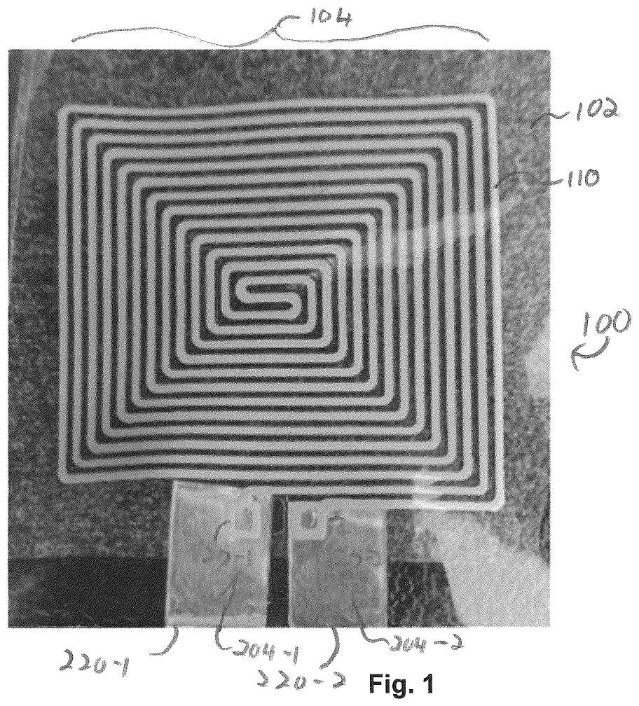

FIG. 1 is a top or plan view of a sensor formed according to configurations herein. Referring to FIG. 1, a sensor 100 as defined herein includes a continuous run 104 of conductive material 110 deposited onto a substrate 102. The continuous run 104 defines a pattern between a plurality of electrodes 120-1 . . . 120-2 (120 generally), where the continuous run 104 defines a resistance. A pattern formed by the continuous run 104 may be spiral, rectilinear, straight or curved or any suitable combination. Generally the run 104 is nonintersecting with other portions of the run (i.e. it does not cross over itself), and has respective electrodes 120 at the terminus ends 204-1 . . . 204-2 (204 generally) formed from the commencement and termination of the deposition or application of the conductive material 110.

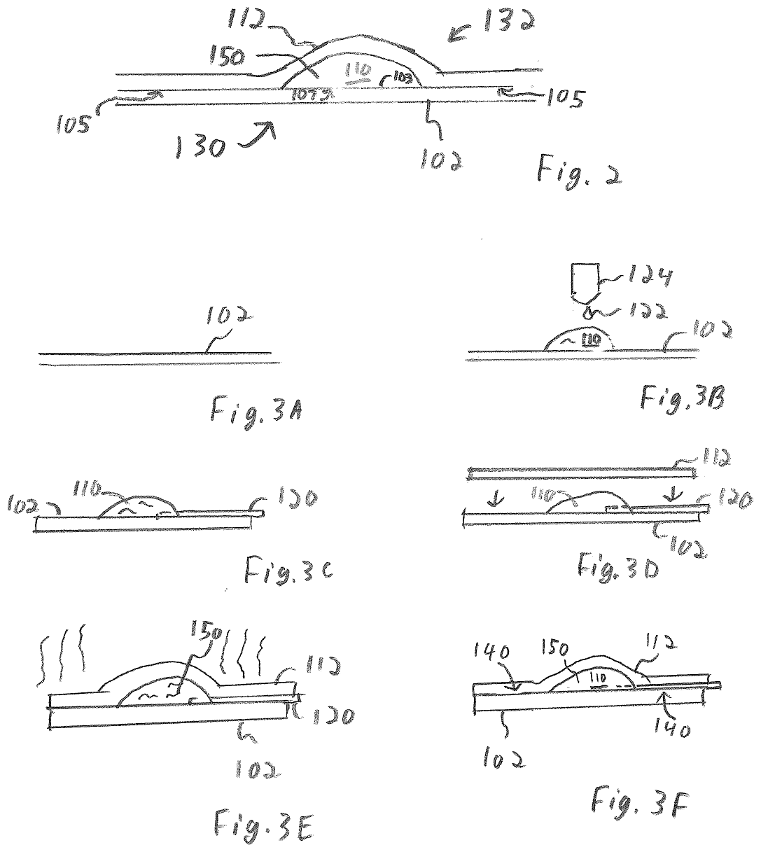

FIG. 2 is a side elevation of an axial view of the sensing medium as in FIG. 1 showing a cross section 130, where the axis is defined by the direction of the run 104. A convex shape 132 is formed from depositing the conductive material 110 onto a flush surface 103 defined by a substrate 102. The convex structure 132 forms when a flexible, stretchable and/or compressible planar material 112 is deposited on the conductive material 110, and fuses or adheres to the substrate 102 in undeposited regions 105, while a channel 150 is effectively defined to contain the conductive material 110 between the flexible planar material 112 and the substrate 102 at the unbonded surfaces 107. It should be noted that the substate and flexible planar material refers to sensors and materials are generally soft, stretchable, and compressible, and thus are responsive to bend, compress, and stretch with the various context of deployment.

As can be seen FIG. 2, the conductive material 110 forms a cross section responsive to pressure against the flexible planar material 112. Such pressure has a tendency to compress the channel 150, such that the resistance decreases from a reduced cross section area of the conductive material 110. When a voltage source is applied across the electrodes 120 or terminals, a circuit is formed of which the electrical resistance varies based on a cross section of the conductive material 110.

FIGS. 3A-3F show formation of the pressure sensor as in FIGS. 1-2. In configurations herein, the method for forming a pressure sensor 100 includes, in FIG. 3A, selecting the substrate 102 from flat stock of a nonconductive material. Typical candidates would be a flexible polymer sheet material such as a thermoplastic elastomer or polyurethane (TPU) or similar. However, any suitable flexible material capable of bonding and flexibility as described herein will suffice.

A print medium is selected, as shown in FIG. 3B, including the conductive material 110 having an elasticity, pliability or fluid consistency for retaining a deposited shape on the substrate. An extrusion nozzle 124 or other process applies the conductive material 110 onto the substrate, where the deposited material holds a shape and does not collapse or run off the substrate. In a particular configuration, the print medium 122 may include a gallium alloy such as an indium gallium alloy, optionally combined with other print carriers, solvents or mediums that facilitate printing/deposition of the conductive material in a form and shape that remains in place in a semi-solid, gel, cream or viscous liquid metal substance. The conductive material 110 thus forms a convex shape having an aspect ration defined by the width and height of the deposited bead of material. It is significant that the conductive material 110 retains a deposited form until the flexible planar material 112 is layered onto the substrate 102.

One or more electrodes 120 (typically 2) are inserted into the deposited conductive material 110 for subsequent connections, as shown in FIG. 3C. The electrodes 120 may be simply placed on the substrate 102 extending into the conductive material 110, as the encapsulation will serve to secure them in place.

The flexible planar material 112 is selected for an ability to bond with the substrate 102, and is applied based on a temperature and pressure at which the flexible planar material will encapsulate and mold to the conductive material 110 without altering or spreading the deposited form, as shown in FIG. 3D. Thus, the conductive material 110 should have a viscosity for retaining a deposited position on the substrate 102. Heating of the flexible planar material 112 causes a bonding or fusing to the substrate from heating and slight melting of the polymer material. In some configurations, the flexible planar material 112 and substrate 102 may be of the same material, such as TPU, thus both having a common melting and bonding temperature.

The combined heat and pressure encapsulate the conductive material 110 as the flexible planar material 112 is layered onto the substrate 102, shown in FIG. 3E, as a sealed channel 150 is defined by the fused material and substrate 102, 112. It is thus apparent that the substrate 102 and the flexible planar material 112 are responsive to heat for forming a fused attachment around the areas where the conductive material 110 was deposited, as shown in FIG. 3F. The operation of adhering and fusing/bonding the flexible planar material 112 to exposed areas of the substrate 102 therefore form a sealed vessel or channel containing the conductive material between the two fused surfaces. The result is a conductive or liquid metal alloy or conductive paste sealed in the channel 150 for compression and pressure sensing.

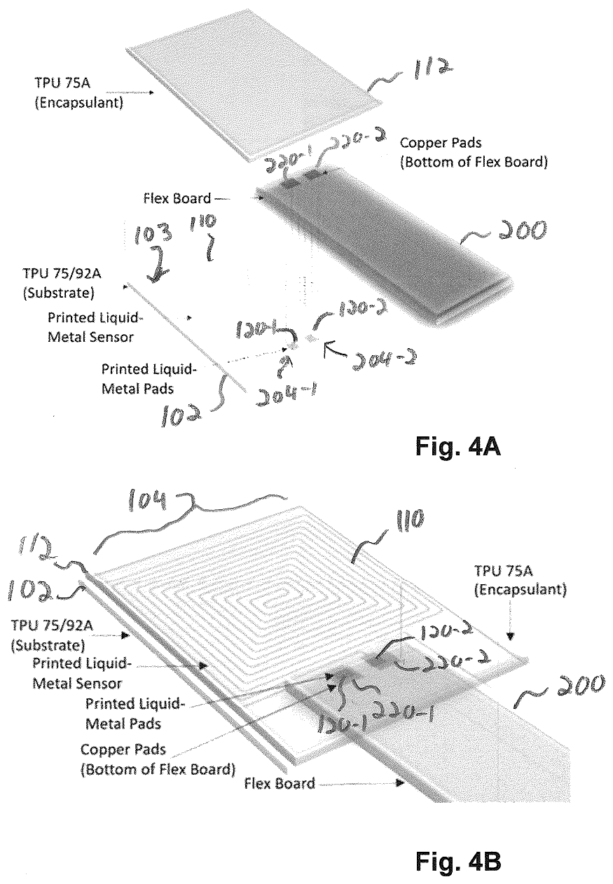

In available configurations, the conductive material 110 may form lines (or features having other shapes) of a conductive deformable liquid/paste/gel, fabricated on a substrate by means of direct ink write (DIW) printing or any other printing or deposition and patterning process. The lines or features could be in any of several patterns including but not limited to spirals, serpentines, loops, inversions and the like. A flex PCB (printed circuit board) or other electrical connection is made to the ends of the liquid metal. The liquid metal and electrical connection are then encapsulated by one of the following methods: heat-pressing or adhesive lamination of a second layer, casting or coating a second layer, or equivalent processes. The images of FIGS. 4A and 4B below shows a typical assembly for the heat-pressed or adhesive-laminated version.

FIGS. 4A-4B show a perspective, exploded view of sensor formation as in FIGS. 1-3. Referring to FIGS. 1-4B, the deformable, flexible pressure sensor as defined herein is formed from a flexible substrate 102 having a flush surface 103. A continuous run 104 of conductive material 110 is formed the flush surface 103. The pair of electrodes 120-1 . . . 120-2 are placed at each terminus 204-1 . . . 204-2 of the continuous run 104, such that the conductive material 110 defines an electrical resistance between the electrodes. Conductive pads 220-1 . . . 220-2 from a circuit board 200 or attached apparatus such as a robotic or sensing circuit engage the electrodes 120 for receiving the sensed voltage or current affected by the resistance.

In FIG. 4B, as the flexible planar material 112 is fused onto the flexible substrate 102 at the exposed regions 105, i.e. between the run 104 of conductive material 110. The convex shape 132 is formed around the conductive material 110 for containing the electrodes 120, pads 220 and conductive material 110 in a fluidic state for deformation.

Depending on the expected deployment temperature, the conductive material 110 may include an alloy selected for a melting point below room temperature, around 70° F. or 25° C. The conductive material may be a gel, cream, emulsion or suspension or other mixture, and is preferable fluidic such that the conductive material has a solidus below room temperature. In particular configurations, the flexible, deformable sensor 100 is integrated into garments or worn equipment, thus a body temperature of the wearer will maintain the operating temperature. In colder environments, a conductive material having a liquid or gel form below freezing (32° F.) may be desirable.

The disclosed approach may operate with precision based on the print or deposition resolution of the extrusion nozzle 124 or other deposition mechanism. In a particular configuration, the conductive material 110 is deposited in a continuous run 104 of a bead having a width of 0.1-0.3 mm and a thickness of 0.1-0.3 mm. In a tight spiral or adjacent run, the pattern may includes parallel runs of the conductive material, such that adjacent parallel runs are between 0.1-0.25 mm apart. Sensitivity is also superior to conventional pressure detectors as the resistance may vary over a range of at least 200% of a minimum resistance when the conductive medium is compressed.

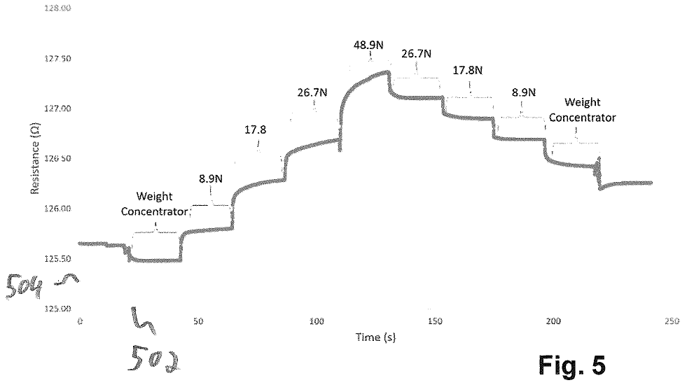

FIG. 5 shows a change in detected resistance in the conductive material 110. The graph of FIG. 5 shows an unfiltered and unprocessed change in resistance of the liquid metal-filled channel 150 over time (axis 502) as the sensor is loaded up to nearly 50 N of force (axis 504), and then unloaded again.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for forming a pressure sensor, comprising:
depositing a conductive material onto a substrate;
encapsulating the conductive material with a flexible planar material layered onto the substrate; and
engaging an electrode in communication with the encapsulated conductive material, the electrode configured for sensing an electrical resistance variation in the conductive material from deformation of the flexible planar material.

2. The method of claim 1 further comprising:
adhering the flexible planar material from a pressure and a temperature applied to the substrate by the flexible planar material, the temperature and pressure:
adhering the flexible planar material to exposed areas of the substrate; and
forming a sealed vessel containing the conductive material between the flexible planar material and the substrate.

3. The method of claim 2 wherein the substrate and the flexible planar material are responsive to heat for forming a fused attachment.

4. The method of claim 2 the substrate and the flexible planar material have a common melting point for responsiveness to heat fusion.

5. The method of claim 1 wherein the conductive material retains a deposited form until the flexible planar material is layered onto the substrate.

6. The method of claim 1 wherein the conductive material has a viscosity for retaining a deposited position on the substrate.

7. The method of claim 1 further comprising depositing a continuous run of conductive material onto the substrate, the continuous run defining a pattern between a plurality of electrodes, the continuous run defining a resistance.

8. The method of claim 1 further comprising depositing the conductive material onto a flush surface defined by the substrate, and forming a convex structure with the flexible planar material on the conductive material.

9. The method of claim 1 wherein the conductive material has a solidus below room temperature.

10. The method of claim 1 wherein the conductive material forms a cross section responsive to pressure, the resistance decreasing from a reduced cross section.

11. The method of claim 6 further comprising selecting a print medium including the conductive material having an elasticity for retaining a deposited shape based on a temperature and pressure at which the flexible planar material is applied.

12. The method of claim 1 wherein the conductive material includes an alloy selected for a melting point below room temperature.

13. The method of claim 1 wherein the conductive material has a width of 0.1-0.3 mm and a thickness of 0.1-0.3 mm.

14. The method of claim 7 wherein the pattern includes parallel runs of the conductive material, such that adjacent parallel runs are between 0.1-0.25 mm apart.

15. The method of claim 10 wherein the resistance has a variance of at least 200% of a minimum resistance.

16. A deformable, flexible pressure sensor, comprising:
a flexible substrate having a flush surface;
a continuous run of conductive material on the flush surface; and
a flexible planar material fused onto the flexible substrate at exposed regions, and forming a convex shape around the conductive material; and
a plurality of electrodes placed at each terminus of the continuous run, the conductive material defining an electrical resistance between the electrodes.

17. The method of claim 16 wherein the electrical resistance varies based on a cross section of the conductive material.
